(19) United States
(12) Patent Application Publication
(10) Pub. No.: US 2015/0339785 A1
(43) Pub. Date: Nov. 26, 2015

(54) SYSTEMS AND METHODS FOR ACCESSING THIRD PARTY DATA ON WEBSITES

(71) Applicant: Entelo, Inc., San Francisco, CA (US)

(72) Inventors: Jonathan P. Bischke, San Francisco, CA (US); John McGrath, San Francisco, CA (US); Farid Aliev, San Francisco, CA (US); Gilles Pirio, San Francisco, CA (US); Vivek Reddy, San Francisco, CA (US); Max Schultz, San Francisco, CA (US)

(21) Appl. No.: 14/814,210

(22) Filed: Jul. 30, 2015

Related U.S. Application Data
(63) Continuation-in-part of application No. 13/910,054, filed on Jun. 4, 2013.
(60) Provisional application No. 61/655,960, filed on Jun. 5, 2012.

(51) Int. Cl. G06Q 50/00; G06Q 10/10; G06F 17/30

(52) U.S. Cl. CPC G06Q 50/01; G06F 17/30867; G06F 17/30528; G06F 17/30554; G06Q 10/1053

(57) ABSTRACT

Systems and methods are provided for accessing and/or aggregating data from third party web sites. An aggregated candidate profile may be created and displayed based on information from a plurality of social networking profiles from various third party web sites. The social networking profiles may be identified based on automated analysis. The aggregated candidate may be created and/or displayed using a browser plug-in.

### CROSS REFERENCE

This application is a continuation-in-part application of Ser. No. 13/910,054, filed Jun. 4, 2013, to which application we claim priority under 35 USC §120, and which claims the priority of U.S. Provisional Application Ser. No. 61/655,960, filed Jun. 5, 2012, which are incorporated herein by reference in their entirety.

### FIELD OF THE INVENTION

The present invention is directed to a database of web profiles corresponding to aspects of the professional characteristics and qualities of individuals.

### BACKGROUND OF THE INVENTION

People involved in evaluation, hiring and recruiting (hereby referred to as “users”) of professionals often attempt to gain as complete of an understanding of a potential job applicant as possible. This is often currently achieved by finding the profiles or websites (“profiles”) of potential applicant or candidates (“candidates”) on one of a number social networking services including, but not limited to, LinkedIn, Facebook, Twitter and Google+.

Once the candidate is discovered on one network a user often attempts to locate the same individual on other networks to gain a more complete picture of the individual. This is often accomplished through methods such as manually traversing links from one profile to another profile (e.g., following a link on a LinkedIn profile to a profile on Twitter), using a general purpose search engine (e.g., Google, Bing, etc.) to conduct a search such as “Ilya Grigorik Github”, etc.

Currently there are systems that allow users to find additional profiles of candidates once they are conversing with those candidates within an email client. Examples of systems that allow for this behavior include Rapportive (a GMail plug-in), Xobni (an Outlook and GMail plug-in) and Gist. However, none of these systems allow for the discovery of associated profiles unless the user is currently conversing with the candidate via the email client. It is not currently possible to use any of the above systems to discover candidate profiles while accessing URLs of profiles for candidates from World Wide Web. A need exists for systems that would be able to find candidate profiles through websites without requiring email correspondence.

In addition, a need exists for users to perform social discovery for candidates by identifying co-workers, professional colleagues and others who may have a relationship with the candidate. A further need exists to identify those social connections directly from third-party websites (where the initial social connection may or may not reside).

Furthermore, a need exists to be able to perform CRM-type functions in regards to a candidate. Further need exists for additional capabilities, such as adding a candidate to a list (or “folder”, “bucket”, etc.), attaching a note or tag to a particular candidate or forwarding that candidate to another user within their organization.

### SUMMARY OF THE INVENTION

Aspects of the invention may be directed to a bookmarklet, browser extension or plug-in which may provide access to aggregated publicly available web profiles for a given person, and display the aggregated data on a third-party website along with enhancements such as Customer Relationship Management (CRM) functionality. Profiles may be aggregated through explicit linking between websites and other algorithmic methods of determination, including probabilistic matching based on permutations and combinations of name, location, occupation, education, keywords, and other identifying information. A plug-in may match the profile being viewed in the browser to those that have been aggregated by a data access and/or aggregation system and then displays the profile to which the URL belongs.

Traditional prior systems do not provide any mechanism whereby one user can do discovery of other potential profiles for a given candidate from the open web. By contrast, systems and methods described herein may provide a software service that allows users to perform discovery of various associated profiles related to a candidate from URLs on the World Wide Web. Data access and aggregation systems and methods described herein may permit the automated discovery of the candidate's associated profiles without requiring email correspondence with the candidate. This may advantageously facilitate information gathering about the candidate from readily available resources.

Systems and methods provided herein may also disclose from within a third-party website when trusted individuals of the user have a pre-defined relationship with the candidate on a social networking service, regardless of whether the pre-defined relationship exists on the social networking service that the user currently resides on.

Various CRM-type functions may be provided that can be performed directly from within the third-party website on which the user resides without having to leave the website and enter a separate CRM application.

An aspect of the invention is directed to a method for accessing data on third party web sites, said method comprising viewing a social networking profile of a candidate on a third party web site; conducting, with aid of a processor, a search for one or more additional social networking profiles of the candidate based on said viewed social networking profile; creating, with aid of a processor, an aggregated profile for the candidate based on the viewed social networking profile and one or more additional social networking profile of the candidate found based on the search; and displaying the aggregated profile on a user interface of a device.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a system for accessing third party data on web sites in accordance with an embodiment of the invention.

FIG. 2 provides an illustration of how profiles from third party data web sites may be unified in accordance with an embodiment of the invention.

FIG. 3 shows an example of an aggregated candidate profile that may be displayed.

FIG. 4 shows an example of a candidate profile provided on a third party web site.

FIG. 5 shows an example of a candidate profile provided on a third party web site with a plug-in activated for the data aggregation.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for accessing third party data on web sites. Various aspects of the invention described herein may be applied to any of the particular applications set forth below or for any other types of data collection and/or aggregation for hiring or recruiting. The invention may be applied as a standalone system or method, or as part of an integrated data aggregation or referral system. It shall be understood that different aspects of the invention can be appreciated individually, collectively, or in combination with each other.

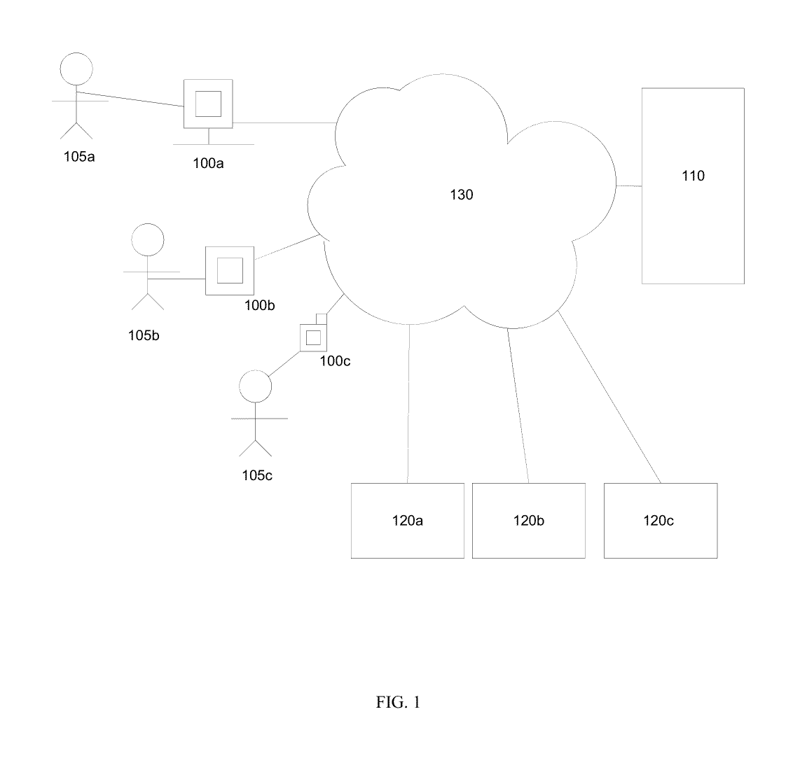

FIG. 1 shows an example of a system for accessing third party data on web sites in accordance with an embodiment of the invention. The system may include one or more user devices 100a, 100b, 100c, a data access and/or aggregation system 110, and one or more third party system 120a, 120b, 120c. The user devices, aggregation system, and/or third party systems may communicate with one another over a network 130. One or more users 105a, 105b, 105c may interact with the system via the user devices.

The devices 100a, 100b, 100c may be network devices. Network devices may include computers whether they be a personal computer, server computer, or laptop computer; mobile devices, such as a tablet, personal digital assistants (PDAs) such as a Palm-based device or Windows CE device; phones such as cellular phones, smartphones (e.g., iPhone, BlackBerry, Android, Treo); a wireless device such as a wireless email device or other device capable of communicating wirelessly with a computer network or other communication network; or any other type of network device that may communicate over a network and handle electronic transactions. One or more of the devices may be handheld devices. Any discussion herein of computers or mobile devices may also be applied to any other network devices as provided.

The devices may permit user interaction with the devices. A user interactive device, such as a mouse, touchpad, trackball, joystick, touchscreen, microphone, capacitive sensor, or inertial sensor may sense an input by a user, which may effect a reaction by the device. The input by the user may include a physical motion by the user and/or audible instructions.

The devices may be the same type of device and/or may include different types of devices. For example, the devices may be a computer 100a, a tablet 100b, and/or a smartphone 100c. Mobile devices may interact with the system.

The devices 100a, 100b, 100c may communicate with a data access and/or aggregation system 110. In some instances, the aggregation system may be implemented on a web server. In some embodiments, the data access and/or aggregation system may operate using one or more server. A server may have a programmable processor capable of performing one or more steps described herein, and/or a memory capable of storing non-transitory computer readable media having code, logic, or instructions for one or more steps. Any description herein of a processor may apply to one or more processors that may individually or collectively perform any of the tasks described. The processor may be programmed to perform the task described. In some instances, the processor may be hardwired to perform the task described. In some instances, the data access and/or aggregation system may be provided on a single server or may be distributed over a plurality of servers. The system may be provided on a cloud computing infrastructure. In some instances, the system may be implemented using a peer to peer structure. The system may be owned and/or operated by an entity that is the same or different from the third parties described herein. The system may be operated on a different platform than the third party platforms.

The devices 100a, 100b, 100c and/or data access and/or aggregation system may communicate with one or more third party system 120a, 120b, 120c. In some instances, the third party systems may be implemented on a web server. In some embodiments, the third party systems may operate using one or more server. A server may have a programmable processor capable of performing one or more steps described herein, and/or a memory capable of storing non-transitory computer readable media having code, logic, or instructions for one or more steps. In some instances, the third party systems may be provided on a single server or may be distributed over a plurality of servers. The third party systems may be provided on a cloud computing infrastructure. In some instances, the third party systems system may be implemented using a peer to peer structure. The third party systems may be owned and/or operated by entities that are the same or different from the aggregation system described herein. The third party systems may be owned and/or operated by the same entity or different entities from one another. Databases of different third parties may be separated from one another. In some embodiments, the third party systems may include social networking services, and/or job placement services. The third party systems may be capable of providing and/or displaying one or more social networking profile. A social networking profile may or may not include employment information and/or resume information.

The communication between a network device, an aggregation system, and/or third party systems may be, for example, a connection between a client computer and a website server over a network 130. One or more servers may communicate with one or more computers or other network devices across a network. For example, a plurality of devices may communicate with a single server, or with a plurality of servers. The network, for example, can include a private network, such as a LAN, or interconnections to the online organizations over a communications network, such as the Internet or World Wide Web or any other network that is capable of communicating digital data, such as a wireless, cellular, or telecommunications network. Each computer or other network device may connect to one or more web server over the network using data protocols, such as HTTP, HTTPS and the like. In some embodiments, communication devices, such as a WiFi module, routers, modems, relay stations, towers, and/or satellites may be employed to aid in the network communications.

A user 105a, 105b, 105c, such as a recruiter, employer, administrator, human resources manager, job candidate, customer of the system, or any other party, may interact with a server, computer, mobile device (e.g., tablet, smartphone) or other network device that may be part of the system. When a computer or other network device is communicating with the web server, the device may have a processor and a memory that may store an operating system (OS) and a browser application or other application to facilitate communications with the web server. For example, the operating system may operate to display a graphical user interface to the user and permit the user to execute other computer programs, such as the browser application. The browser application, such as Microsoft Internet Explorer, Mozilla Firefox, when executed by the processor, permits the user to access the World Wide Web as is well known. Similarly, other applications or “apps” on mobile devices may be used. A server, computer, or other network device that may host the workflow designer may have a display which displays a graphical user interface. Any display known in the art may be used including, but not limited to, a cathode ray tube, a liquid crystal display, a plasma screen, a touchscreen, an LED screen, or an OLED display.

The devices and/or servers may include one or more processor and/or memory. The processor may be capable of executing one or more step of the method for accessing and/or aggregating third party data on web sites. One or more steps may occur as dictated by one or more set of rules. The rules may dictate when a user performs one or more steps, or when a machine automatically performs one or more steps. The rules may permit automated data access and/or aggregation based on a set of one or more conditions. The processor may permit the automated management of electricity delivery without requiring human intervention at one or more steps. The devices and/or servers may have memory that may include non-transitory and/or tangible computer readable media which may contain instructions, logic, data, or code that may be stored in persistent or temporary memory of the computer or other device, or may somehow affect or initiate action by the computer or other device. Any of the steps described herein may be performed with aid of a programmable processor, which may act in accordance with non-transitory computer readable media as described herein. The memory may include one or more databases.

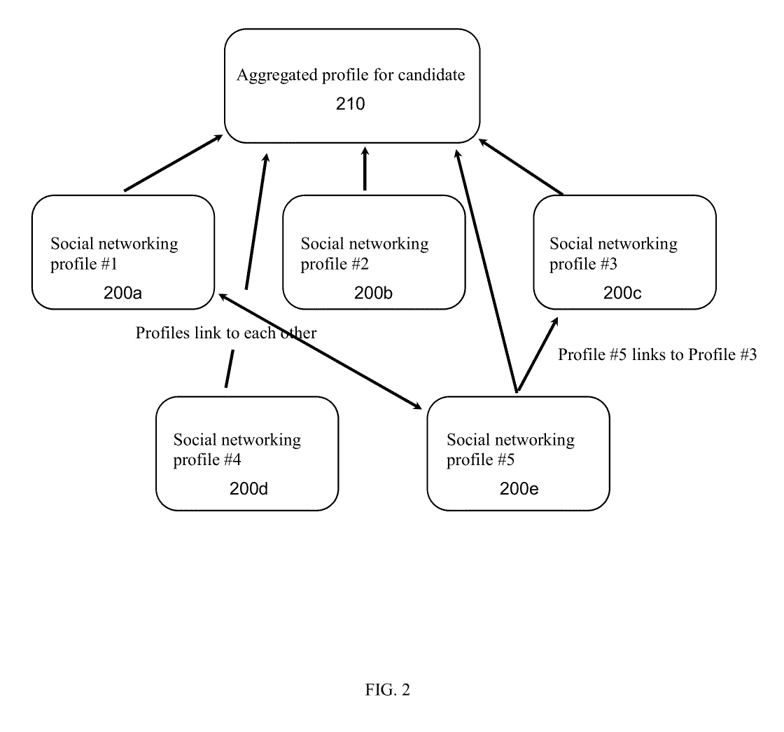

FIG. 2 provides an illustration of how profiles from third party data web sites may be unified in accordance with an embodiment of the invention. Third party data web sites may include social networking profiles for one or more candidates 200a, 200b, 200c, 200d, 200e. The social networking profiles may be displayed via the third party data web sites. Social networking profiles may be viewable on a display of a device, such as a mobile device, computer, or any other described herein. The social networking profiles may be shown on a browser display of a user interface. Alternatively, data for the profiles may be stored without being displayed on the web sites. Third parties may or may not be affiliated and/or associated with one another. The profiles may be hosted on separate servers and/or platforms. The third parties may operate using separate physical servers and/or platforms, or may be at different locations.

In some instances, each third party data web site may have one or more different social networking profiles. Such social networking profiles may be provided for the same individual. For example, an individual may have five different social networking profiles via five different third party web sites. The third party web sites may or may not be related to employment or job experience. Some of the web sites may have a higher employment or resume focus than the others. Third party web sites may permit a user to search job postings and/or display their resume or job qualifications. Third party web sites may permit a user (e.g., job candidate) to post interests, skills, experience, or any other information about the user for the purposes of seeking employment and/or other activities. Third party websites may permit a user (e.g., recruiter, prospective employers) to post job openings and criteria and/or search through candidate profiles. Examples of third party web sites may include but are not limited to Dribbble, Google+, Facebook, MySpace, Github, LinkedIn, Meetup, Quora, Stack Overflow and Twitter.

Third party web sites may permit a user to connect with or link to another user using the same third party web site or another third party web site. For example, a user may be able to provide a link to the user's acquaintances on the user's social networking profile. The link may be displayed on a user interface suing the user's social networking profile. The social networking profiles of the user's acquaintances may or may not be accessible and/or viewable via the link.

Third party web sites may also permit a user to connect with or link to another social networking profile for the same user on the same third party web site or another third party web site. For example, the user can link the user's Github account with the user's Facebook account. A user interface may show the user's Facebook account which may display a link to the user's Github account. The social networking profiles of the user may or may not be accessible and/or viewable via the link.

An aggregated profile 210 may be created for a candidate. The aggregated profile may be created for a candidate based on information collected from the third party web sites. For example, if a third party web site is determined to have a profile of an individual that matches the candidate, information from the third party web site may be considered for aggregation in the aggregated profile. In some instances, a plurality of third party web sites may be detected having social networking profiles with a high likelihood of correlation with the candidate. Information from each of the social networking profiles may be considered for aggregation. For example, it may be determined that the individuals described in social networking profile #1 200a, social networking profile #2 200b, social networking profile #3 200c, social networking profile #4 200d, and social networking profile #5 200e have a high likelihood of being the candidate. Such a determination may be made based on one or more factors. Such factors may be weighed and/or balanced.

A social networking profile may be determined to belong to a job candidate and/or may define the candidate to be searched. For example, the social networking profile may be viewed when a request is provided to create an aggregated profile for the candidate. The viewed social networking profile may be the profile determined to be associated with the candidate.

The aggregated profile for the candidate may include information from one or more of the social networking profiles. The subject matter of the social networking profiles may be assessed to determine whether to include in the aggregated profile. For example, if the aggregated candidate profile focuses on employment information, the social networking profiles may be mined for employment related information. In another example, if the aggregated candidate profile focuses on a hobby, the social networking profiles may be mined for information relating to that hobby. Other information on the social networking profiles may be deemed irrelevant and need not be included on the aggregated candidate profile. For example, if a social networking profile includes information about the individual's pet, in some instances this may be deemed irrelevant to include on a job candidate profile.

The assessment may be made based on whether the information in the social networking profiles fall into a category that are relevant for the aggregated candidate profile. For example, the aggregated candidate profile may be compiled for one or more category (e.g., employment, social, hobby, research, etc.). The third party web sites having social networking profiles that are determined to belong to the same candidate may be mined to recite information belonging to the same category, or a plurality of categories that may be relevant to the selected category (e.g., for an aggregated employment profile, the social networking profiles may provide information relating to employment history, education, language skills, miscellaneous skills).

In some instances, certain items of general information may be included regardless of category or subject matter in the aggregated candidate profile. Alternatively, all information may be deemed relevant and may be included on the aggregated profile. General information relating to candidates (e.g., contact information) may be provided in the aggregated profile.

In some instances, information from the social networking profiles may or may not be duplicative. The information may be assessed so that the duplicative information is only provided a single time. The information from the various social networking profiles may also be normalized in order to provide a consistent display in the aggregated candidate profile. One or more term on a social networking profile may be translated into a consistent form on the aggregated candidate profile. In some instances, ontological relationships may be determined between the information provided in different social networking profiles in order to determine whether the social networking profiles are displaying the same underlying information and to consolidate the information as needed.

FIG. 2 provides examples of both direct linking and heuristic matching in connecting social networking profiles with a candidate.

In terms of direct links, social networking profiles #1 and #5 link to each other. Linking may indicate that the individual described by both social networking profiles are the same. Such a link may be reciprocal in that social networking profile #1 links to social networking profile #5 and social networking profile #5 links to social networking profile #1. Social networking profile #3 may be linked to by social networking profile #5 (the link is not reciprocal in the sense that social networking profile #3 does not link to social networking profile #5). These direct links may be helpful in determining which social networking profiles belong to the same candidate. For example, the direct linking between the social networking profiles may indicate that the social networking profiles belong to the same candidate. The links may be forms of self-identification by the individuals of the social networking profiles. For example, an individual may link the individual's first social networking profile with a second social networking profile. Alternatively, the linking may be performed by another individual. The links may be visible on the social networking profile. For example, a user may click on a link to access another social networking profile. Alternatively, the links need not be visible, but may be provided on the back end.

Systems and methods herein may utilize the links to find additional social networking profiles that likely belong to a candidate. For example, if social networking profile #1 is deemed to belong to the candidate, then social networking profiles that are linked to social networking profile #1 may also be deemed to belong to the candidate. In this example, social networking profile #1 may be a source profile. This may include single or multiple degrees of linking. For example, social networking profile #5 is a first-degree linked profile to profile #1. Social networking profile #3 may be a second-degree linked profile to profile #1 since it is not directly linked to social networking profile #1. The direct linking may be searched for a predetermined number of linking degrees (e.g., one, two, three, four, five or more), or may be searched for all linked profiles regardless of degree. Such links may be detected whether they are reciprocal, one way from the source profile, or one way to the source profile.

Social networking profiles #2 and #4 are not linked to any other social networking profiles individuals but heuristics may be used to ascertain, with strong probability, that these profiles are for the same individual as profiles #1, #3 and #5. Heuristic matching may occur by detecting one or more factors that are identical between the various social networking profiles. In some instances, the factors may be assessed on a whole to determine the likelihood that the social networking profiles belong to the same individual. The factors may be weighted so that one or more of the factors have different weight and/or the same weight. For example, the individual's name may be given more weight than their location, which may be subject to frequent change. In some examples, certain single factors may offer a high degree of certainty or likelihood of belonging to the same candidate (e.g., social security number) as long as no red flags are provided (e.g., different birth dates). The factors may include data which may be used for heuristic matching, such as first name, last name (surname), social security number, birth date, birthplace, phone number, email address, location, employer, job title, employment history, education, technical skills, language skills, hobbies, profile pictures, and/or any other factors.

In some instances, in order for a social networking profile to belong to the same individual as another, a combination of factors may be weighted and assessed. In some instances, factors considered to be more dispositive of a user's identity may be given greater weight. In some instances, the source of the information may be considered for reliability, and sources deemed more reliable may be granted greater weight. The factors may be added. In some instances, the matching factors may be assigned a score and added. If the added factors pass a predetermined threshold score, the social networking profiles may be deemed to belong to the same individual. As previously described, any of these steps may be performed automatically with aid of one or more processors, which may not require human intervention to perform the steps.

Any techniques, such as direct linking or heuristic matching, or a combination thereof, may be used to determine that a plurality of social networking profiles belong to the same individual. In some instances, a direct linking analysis may occur prior to heuristic matching, or vice versa. Alternatively, both may occur in parallel, or may occur in a cyclic or staggered manner until the analysis is complete. The social networking profiles that are deemed to belong to the same individual may be used to provide information for an aggregated profile for the individual. Some or all of the information from the social networking profiles may be used in the aggregated profile. Each of the social networking profiles may result in contributing information to the aggregated profile. Alternatively, only some of the social networking profiles may result in contributing information to the aggregated profile (e.g., if information is duplicative or not relevant for the aggregated profile).

In some instances, an aggregated profile may be stored in a database. The aggregated profile may be stored in a database of a data access and/or aggregation system. Such information may be stored temporarily or may persist over time. The information may be linked to or associated with a user that initiated the creation of the aggregated profile. For example, the aggregated profile may be accessible by a third party prospective employer who was viewing a social networking profile of the candidate and initiated the creation of the aggregated profile for the candidate. In other instances, the aggregated profile need not be stored persistently, but may be created and/or pulled together whenever the creation of the aggregated profile is initiated.

FIG. 2 illustrates how various social networking profiles may be unified in the systems and methods described herein. Such aggregation and/or unification may occur for a candidate with whom the user has no prior correspondence (e.g., email, chat), connection, or communication. In some instances, a prior correspondence, connection, or communication may have occurred, but need not be utilized and/or is not utilized in the data aggregation and/or unification. In some instances, a prior correspondence, connection, or communication need to not be displayed with an aggregated profile.

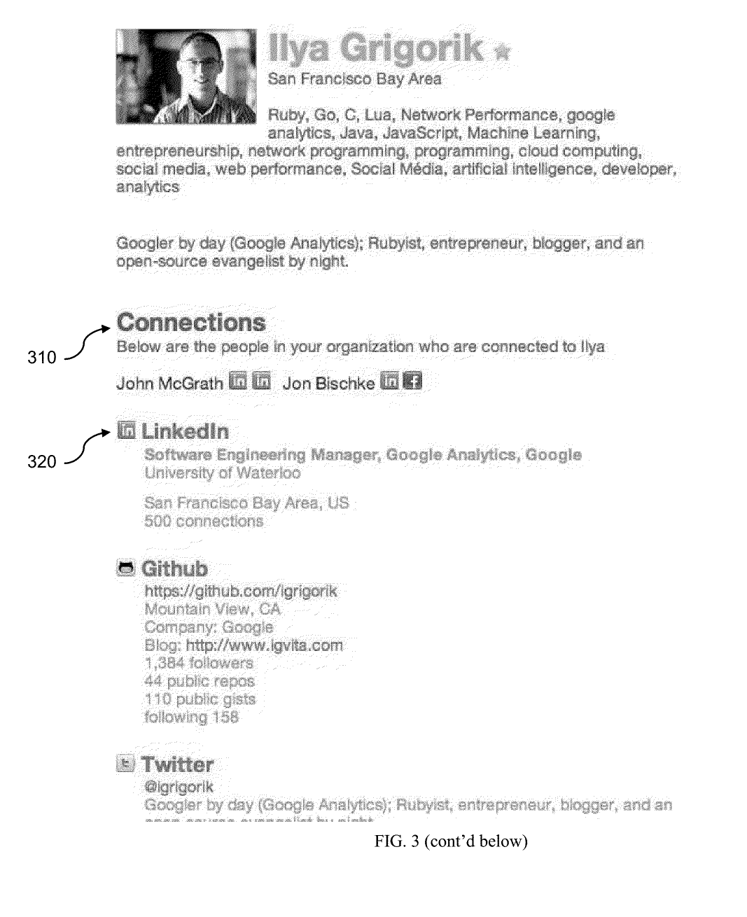

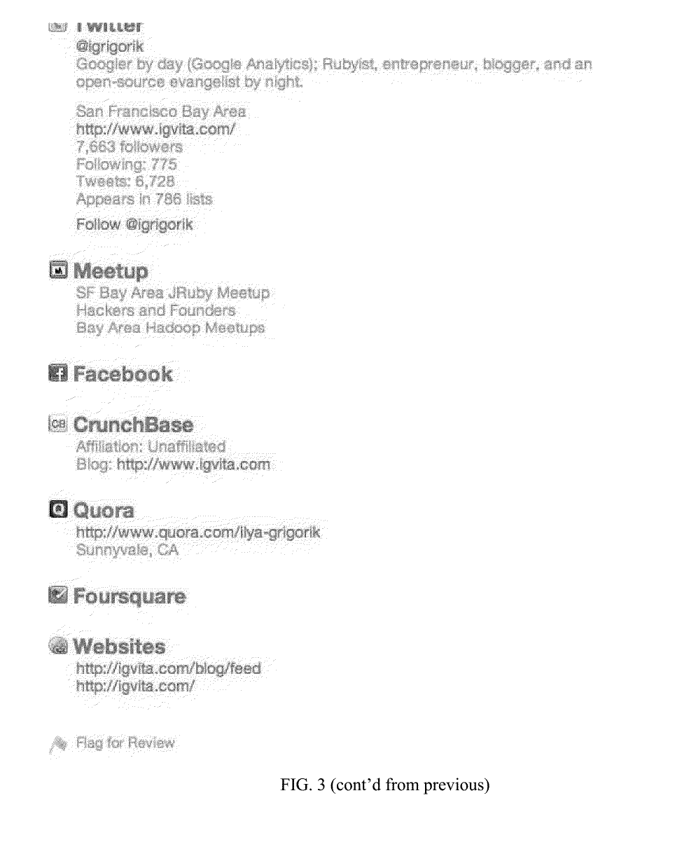

FIG. 3 shows an example of an aggregated/unified candidate profile that may be displayed. The aggregated candidate profile may be shown on any display (e.g., screen) of a device, and may be viewable by a user of the device. A user interface on the display may show the aggregated profile. The aggregated candidate profile may represent a unified view of an individual's professional social profiles. These profiles may include, but are not limited to, profiles on sites such as Dribbble, Facebook, Github, LinkedIn, Meetup, Quora, Stack Overflow, Twitter, or any other sites known or later developed in the art. The sites may also include websites hosted and/or operated by the third parties or candidate. Any description of third parties may or may not include candidate web sites and/or user (e.g., employer, searcher) web sites.

Unified profiles may be assembled in various ways. Such assembly may incorporate searching for additional profiles based on an identified profile. Such searching and/or assembly may occur in an automated fashion without requiring user input. Such searching and/or assembly may occur on the back-end once the searching has been initiated.

In one example, a search engine-like crawler may traverse links from one social profile to another. For example, a candidate may link from his Twitter profile to his Quora profile. The crawler will traverse this link, associating both profiles with the candidate. The crawler application may be capable of traversing reciprocal links and/or one way links (e.g., linked from a first social profile to a second, or vice versa). Thus, direct linking may be used to determine that multiple social networking profiles belong to the same individual.

Another way of unifying a profile may be through heuristics. An algorithm may take into account data such as first name, last name (or “surname”), location, employer, job title and/or other details to assess the probably that a social networking profile on one site is for the same individual as a social networking profile on a different site. For example, looking at the first name “Ilya”, the surname “Grigorik” and location data of “Mountain View, Calif.” on the site Github and the first name “Ilya”, the second name “Grigorik” and location data of “San Francisco Bay Area” on the site Twitter, an intelligent prediction can be made that these are indeed the same individual. In some embodiments, automated ontologies may be provided that may be used to assist in determining whether certain data fields (e.g., location) are consistent even if worded differently. Certain information is indexed from these social profiles and included on the data aggregation profile along with an external link to the associated website.

A search engine-like crawler may scan the web for profiles that include one or more factor that matches the individual. Heuristic matching may be used for such determination. The crawler may scan the World Wide Web, or may scan only certain pre-determined sites and/or associated sites, such as third party sites.

In addition, a user of the data aggregation and/or unification service may contribute his or her social connections (using sites such as, but not limited to, LinkedIn, Facebook, Google+ and Twitter) to the service. This is accomplished using third-party application programming interfaces (APIs). In addition, other member of the user's organization may also contribute their connections. Furthermore, individuals outside the user's organization (considered “trusted individuals” which could be friends, family, advisors, investors and board members) can contribute connections as well. The latter two groups are known as “contributors” (to differentiate their status from “users”).

The unified profile may be displayed on a video display of a device, such as those described elsewhere herein. The unified profile may be part of a graphical user interface.

When a unified profile is displayed on the service, special designation 310 may be given to candidates who are connected on one or more social networks to users or contributors for that organization. In the example illustrated, the candidate Ilya Grigorik is connected to the user John McGrath on LinkedIn and to the user Jon Bischke on Facebook and LinkedIn. For example if a company or organization is searching for job candidates, the unified profile may indicate whether the candidate knows anyone that is a part of that company or organization, or is otherwise associated with that company or organization. The unified profile may indicate whether the candidate knows any employees of that organization, business partners of that organization, clients of the organization, customers of the organization, or individuals who have any other relationship to the organization.

In some instances, only first degree connections may be considered (e.g., determines whether candidates know anyone who is actually a part of the company or organization or directly associated with the company or organization). In other examples, additional degrees of connections may be considered (e.g., 2^{nd}, 3^{rd}, 4^{th}, 5^{th}, or more). For example, the system may determined whether the candidate knows anyone who knows someone who is a part of or is directly associated with the company or organization. In some instances, the system may indicate how the candidate knows the individual in the company or organization, or the social link(s) between the candidate and the individual in the company or organization.

The connections may appear on the display, along with specifics about how the candidate is connected to the other individuals. The specifics may include one or more icon indicating the third party social networking site(s) through which the candidate is connected to the other individuals.

The unified profile may also display information about the candidate's other social networking profiles 320. For example, the unified profile may list out the social networking profiles that have been deemed to belong to the candidate. Such information may be a summary of the information provided on the respective social networking sites. For example, the candidate Ilya Grigorik may be seen to have profiles on LinkedIn, Github, Twitter, Meetup, Facebook, CrunchBase, Quora, Foursquare, and various websites.

A user may be able to select a portion of the unified candidate profile to receive further details about the candidate. For example, clicking on a link about one of the social networking sites may direct the user to the candidate's social networking profile from the selected site. Alternatively, the user may remain on the unified profile but be presented with further details about the candidate gleaned from the selected site.

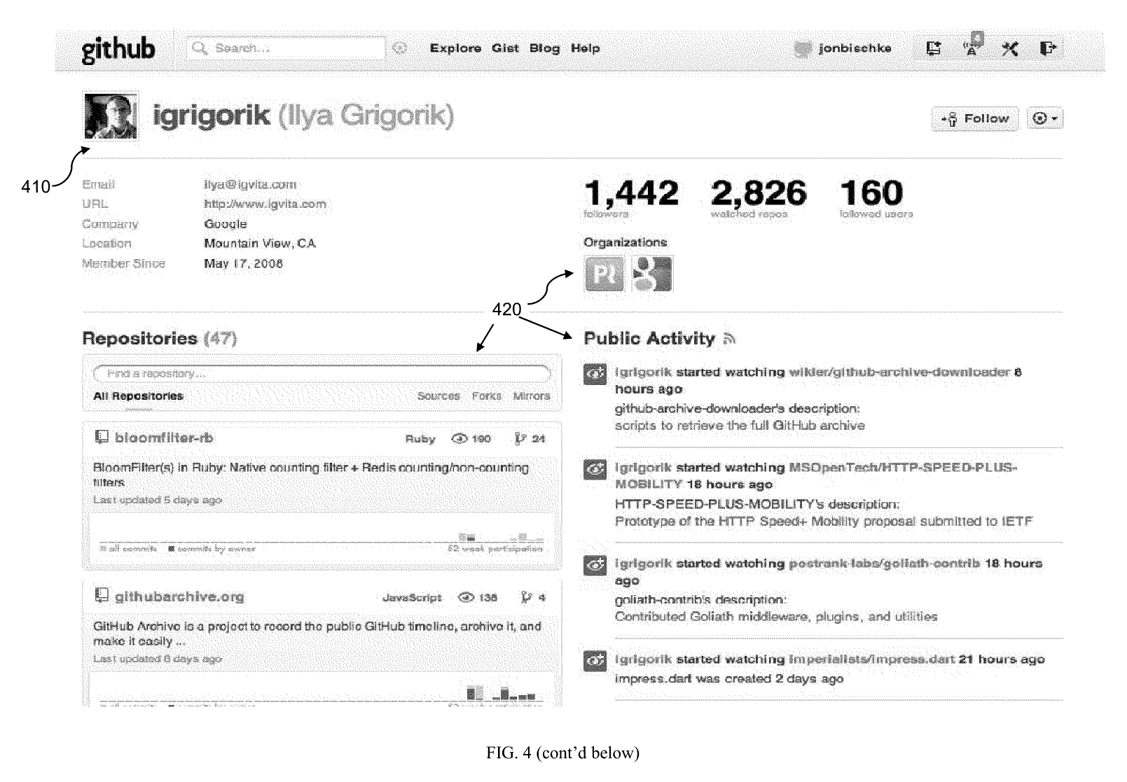

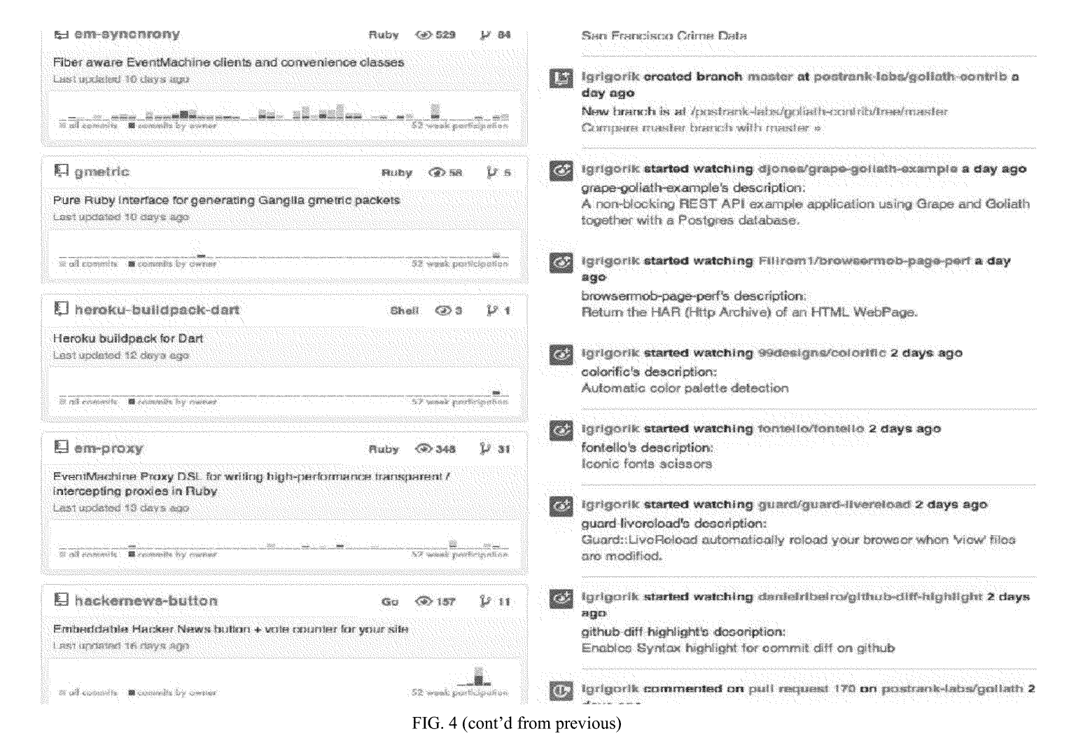

FIG. 4 shows an example of a candidate profile provided on a third party web site. For example, FIG. 4 shows a standard view of a candidate on the website Github.com. In some examples, the candidate profile on the third party web site may include information about the candidate 410, such as the candidate's name, contact information, website, company, location, and/or membership information. Additional information 420 such as connections, comments, activities, or repositories may be included.

The profile on the third party web site is shown prior to display of a unified profile. The profile may be displayed on a graphical user interface on a display of a device. The profile may be displayed without additional features or panes overlying the profile.

The third party website profile may be a starting point profile. The starting point profile may be determined to belong to the candidate. The starting point profile may define the candidate for whom the data access and/or aggregation is occurring. Direct linking or heuristic matching may be performed based on this profile.

In some instances, the unified profile may be provided as a plug-in. Once activated or initiated the unified profile may be displayed on the third party web site. The unified profile may be displayed in the same graphical user interface as the third party web site.

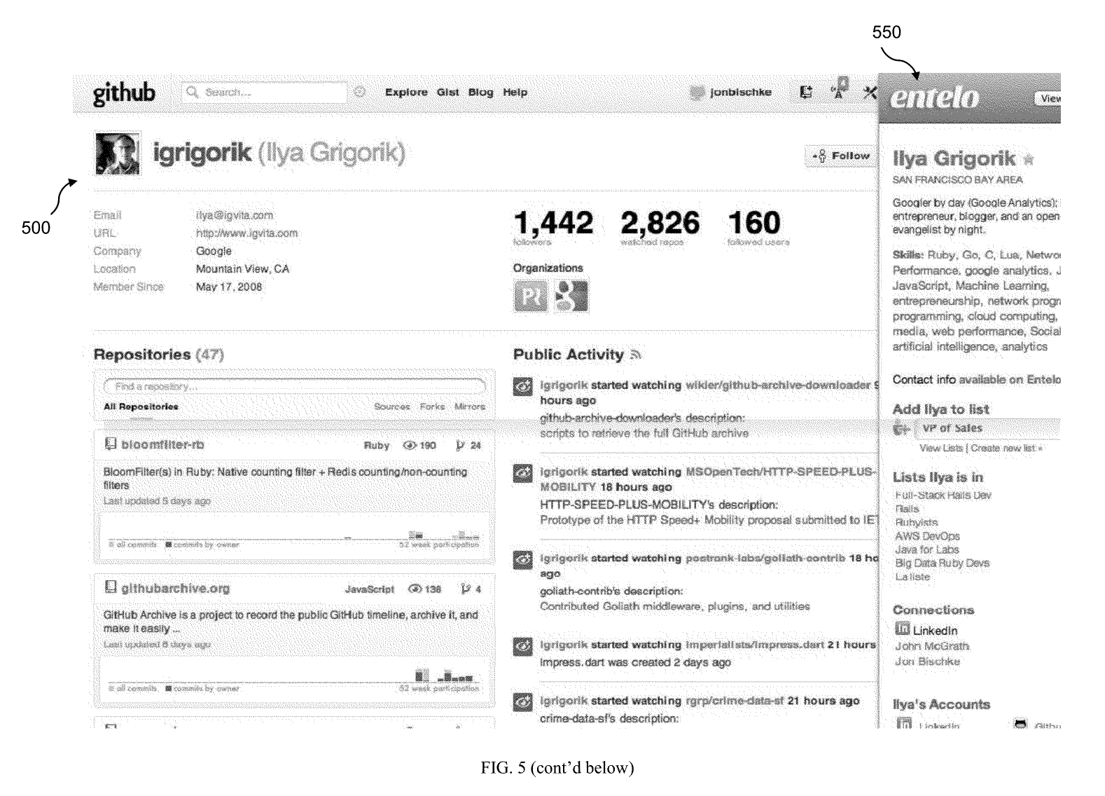

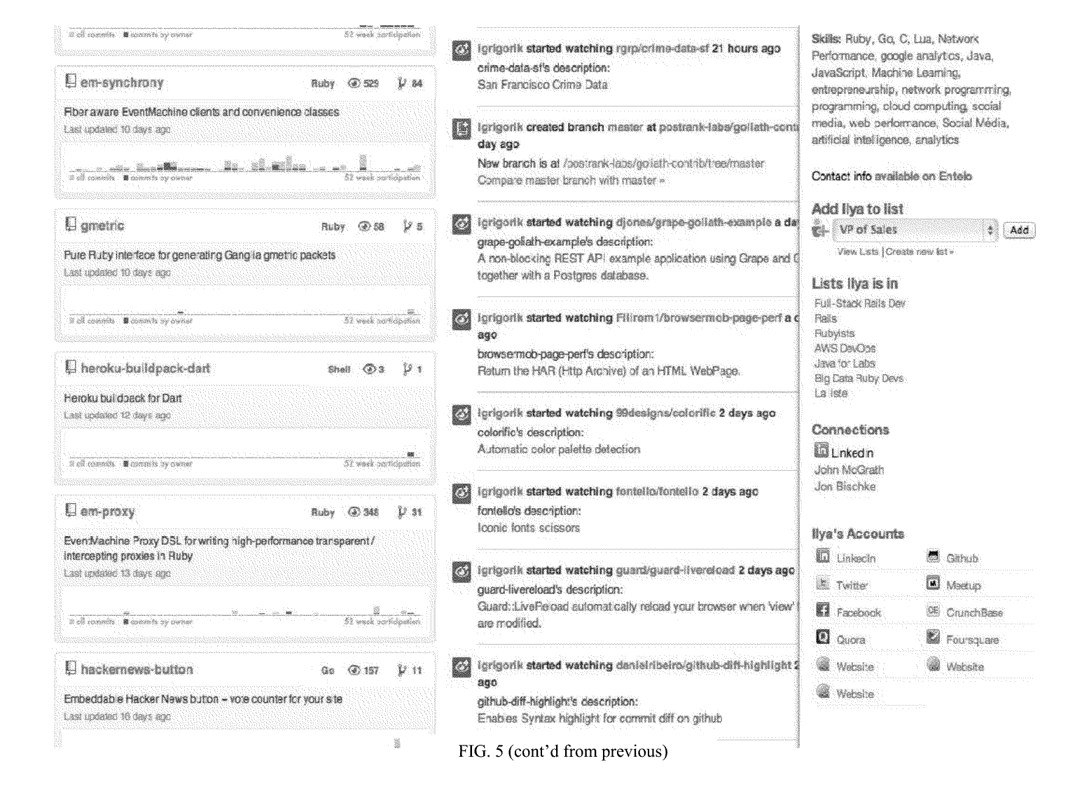

FIG. 5 shows an example of a candidate profile provided on a third party web site 500 with a plug-in activated for the data aggregation showing the unified profile 550. Unified profile may be provided using a browser plug-in (which may also commonly referred to as a “bookmarklet”, an “extension” or a “plug-in”, specifically known as the “Entelo Bar”, the “Entelo Sidebar” or the “Entelo bookmarklet”) that can be activated by a user browsing a third-party site that is one of the sites indexed by the data access and/or aggregation service.

The plug-in may be downloaded to a device of the user. Alternatively, the plug-in may operate on a browser of the user device without requiring a download.

In some embodiments, the third party web site may be monitored and/or indexed by the data access and/or aggregation service.

When the plug-in is activated a database look-up may be performed that can compare the profile on the third-party site with all of the profiles in the system database. For example the system may be designed to automatically search particular web sites belonging to various third parties. There may be a pre-defined group of third parties that are automatically considered. Alternatively, the web may be crawled without requiring a pre-defined group of third parties. The third parties may be hosts for social networking sites. These may include job posting and/or searching sites.

When an exact match or an equivalent match occurs, the plug-in displays a unified profile in the graphical user interface. For example, the unified profile may be displayed as part of an overlay in the browser window that is a version of the profile displayed in FIG. 5. The overlay may be displayed in a selected region of the browser window, and optionally may not cover up the entirety of the third-party site. In some embodiments, the overlay may be displayed on the right side of the browser window, the left side of the browser window, the top of the browser window, the bottom of the browser window, a central region of the browser window, or any other portion of the browser window. The overlay may be opaque and/or translucent. The overlay may or may not cover a portion of the candidate displayed on the third party site. The unified profile may be displayed adjacent to third party profile. The same user interface may simultaneously display the third party web site with the profile, and the aggregated profile that incorporates the information from a plurality of third party web sites.

In some instances, the third party social networking profile may provide all of the information needed in order to initiate a data access and/or aggregation method. For example, viewing and/or identifying the third party social networking profile may be sufficient to develop the aggregated profile, without requiring any other information or prior contact. Separate communications (e.g., email) need not be required in the creation of the aggregated profile. The third party social networking profile may be used as the basis for the creation of the aggregated profile.

Links from the third party social networking profile may be automatically accessed to aid in the development of the aggregated profile. Information/content from the third party social networking profile may automatically provide basis for heuristic matching and/or comparisons to build up the aggregated profile.

This aggregated profile may contain additional social profiles for the candidate, social connections the candidate may have to users and contributors of the organization and customer relationship management (CRM) functionality.

The user can then perform a number of different actions, including but not limited to, linking to other third-party websites that are different from the third-party website currently being browsed, linking to the full profile for the candidate on the data access and/or aggregation website and performing CRM actions. In some embodiments, a user may manually link an identified social networking profile of a candidate to one or more additional social networking profiles on other third party web sites. Alternatively, the system may automatically link the additional social networking profiles without requiring human intervention from the user.

When CRM actions are performed, an update may be made to the record in the database for the candidate on the data access and/or aggregation service. When the user visits the data access and/or aggregation service, additions and modifications made directly through the plug-in are visible. For example, if the user adds the “Ilya Grigorik” candidate to a list entitled “Ruby on Rails Engineers” via the plug-in, the next time the user visits the service website and performs a lookup of the “Ruby on Rails Engineers” list, the candidate “Ilya Grigorik” will appear on that list. Candidate information, such as aggregated profiles, may be stored and/or organized into one or more lists, sublists or other type of grouping levels. Notes about the candidate may be stored and/or associated with the candidate.

Thus, settings and/or updates performed by the users may persist in memory. The data may be organized by organization/company. For example, one or more users of an organization/company may access the system. For example, user #1 may create an aggregated profile for candidate #1 and store it. User #2 may create an aggregated profile for candidate #2 and store it. In some instances, user #1's settings relating to candidate #1 may only be viewable and/or accessible by user #1. Alternatively, both user #1 and user #2 may view and/or access information relating to candidate #1. In some instances, only one of the users or both users may alter information relating to candidate #1. The same may apply to candidate #2. In some instances, different users may have different data access and/or writing privileges, which may define which information may be accessed by which user. Aggregated profiles may be viewable by all users of an organization, a single user of the organization, or a subset of users of the organization.

CRM actions supported by the plug-in may be both read and write in nature.

CRM actions may include adding a candidate to a list, folder or bucket. One or more tags relating to one or more categories may be associated with the candidate. Such tags may include keywords or other characterizations of the candidate. They may include a position or type of position the candidate may fill or be considered for. They may also include skills or experience of the candidate, or individuals that the candidates know. In some instances, they may include a rating for the candidate. Such specifics of the candidate may persist over the use of the system.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for accessing data on third party web sites, said method comprising:
viewing a social networking profile of a candidate on a third party web site;
conducting, with aid of a processor, a search for one or more additional social networking profiles of the candidate based on said viewed social networking profile;
creating, with aid of a processor, an aggregated profile for the candidate based on the viewed social networking profile and one or more additional social networking profiles of the candidate found based on the search; and
displaying the aggregated profile on a user interface of a device.

2. The method of claim 1 wherein conducting the search includes utilizing a web crawler to identify the one or more additional social networking profiles that are linked to and/or from the viewed social networking profile of the candidate.

3. The method of claim 2 wherein the web crawler searches for one or more second degree social networking profile linked to and/or from the one or more identified additional social networking profiles.

4. The method of claim 1 wherein conducting the search includes heuristic matching of content between the viewed social networking profile and the one or more additional social networking profiles.

5. The method of claim 1 wherein the aggregated profile is displayed on the third party web site simultaneously with the viewed social networking profile.

6. The method of claim 1 wherein the aggregated profile is created and displayed with aid of a browser plug-in.

7. The method of claim 1 wherein conducting the search does not include information based on a prior correspondence with the candidate.

8. The method of claim 1 wherein the aggregated profile is stored in memory and is associated with one or more organizational tag in the memory.

9. A method of creating an aggregated profile of a candidate, said method comprising:
conducting, with of a processor, a search for one or more social networking profiles of the candidate, wherein conducting the search does not include information based on a prior correspondence or contact with the candidate;
creating, with aid of a processor, an aggregated profile of the candidate based on the one or more social networking profiles of the candidate found based on the search; and
displaying the aggregated profile on a user interface of a device.

10. The method of claim 9 wherein the aggregated profile of the candidate does not include at least some information from the one or more social networking profiles deemed irrelevant to the candidate's candidacy.

11. The method of claim 9 wherein conducting the search includes utilizing a web crawler to identify the one or more additional social networking profiles that are linked to and/or from a viewed social networking profile of the candidate.

12. The method of claim 9 wherein conducting the search includes heuristic matching of content of the one or more additional social networking profiles with known information about the candidate.

13. The method of claim 12 wherein the known information about the candidate is derived from a viewed social networking profile of the candidate.

14. The method of claim 12 wherein the heuristic matching considers one or more factors that are weighted and summed to determine whether the sum exceeds a predetermined threshold.

15. A system for displaying an aggregated profile of a candidate, said system comprising:
a processor configured to receive information from one or more third party databases storing social networking profiles from third party social networking sites and to create an aggregated profile for the candidate based on the social networking profiles from the one or more third party databases;
a memory configured to store the aggregated profile; and
a display showing the aggregated profile simultaneously with a social networking profile.

16. The system of claim 15 wherein the social networking profiles from the third party social networking sites are selected based on the displayed social networking profile.

17. The system of claim 16 wherein the social networking profiles are selected based on (1) one or more links to and/or from the displayed social networking profile, or (2) heuristic matching between the displayed social networking profile the social networking profiles from the third party social networking sites.

18. The system of claim 15 wherein the aggregated profile is displayed with aid of a browser plug-in.

19. The system of claim 15 wherein the aggregated profile is displayed without displaying a prior correspondence or communication with the candidate.

20. The system of claim 15 wherein the aggregated profile displays connections from the candidate to other individuals associated with an organization to which the candidate is applying.

21. The system of claim 15 wherein the aggregated profile displays information pertaining to the third party social networking sites that are included in the aggregated profile.
